(19) United States
(12) Patent Application Publication
(10) Pub. No.: US 2011/0242271 A1
(43) Pub. Date: Oct. 6, 2011

(54) Synthesizing Panoramic Three-Dimensional Images

(75) Inventors: Abhijit Ogale, Mountain View, CA (US); Stephane Lafon, Sunnyvale, CA (US)

(73) Assignee: Google Inc., Mountain View, CA (US)

(21) Appl. No.: 12/752,007

(22) Filed: Mar. 31, 2010

(51) Int. Cl. H04N 7/00; G06T 15/00

(52) U.S. Cl. 348/36; 345/419; 348/E07.001

(57) ABSTRACT

A method for synthesizing three-dimensional images is provided. A displacement map based on distance data, is generated for a two-dimensional image. The distance data represents a distance between an image object and a position. A shifted version of the two-dimensional image is then produced based on the displacement map. The two-dimensional image and the shifted version of the two-dimensional image are then combined to produce a three-dimensional image. A system is also presented.

### BACKGROUND

1. Field of the Invention

The present invention relates generally to the field of three-dimensional imagery.

2. Background Art

Human beings are able to perceive depth by using binocular vision to view the same scene from two slightly different perspectives. Depth can be simulated in two-dimensional images by capturing two different images of a scene where each image provides the same perspective as would be viewed by a human eye. The different images are combined to create a single three-dimensional (“3-D”) image for a viewer, who typically wears special 3-D eyeglasses that commonly use one of either a red or cyan filter for each eye.

However, this approach requires that two separate two-dimensional images of a scene be captured. The images must be captured using special camera arrangements, involving a pair of cameras or a single camera that can be moved between two positions in rapid succession. Alternatively, special camera equipment, such as a stereo camera with two pairs of lenses and image sensors, must be used. Moreover, this approach works only for images with a limited field of view. The separate images present a scene with a limited field of view, as opposed to a scene with a full field of view, such as in a panoramic image. Therefore, this approach cannot be used to create panoramic three-dimensional images.

### BRIEF SUMMARY

Accordingly, new methods and systems for creating three-dimensional images using a single two-dimensional image of a scene are needed. New methods and systems for creating panoramic three-dimensional images using existing image capturing technology are also needed.

Embodiments of the present invention relate generally to synthesizing three-dimensional images, and more particularly, to synthesizing a three-dimensional image from a two-dimensional image.

In one embodiment of the present invention, there is provided a method for synthesizing three-dimensional images that includes generating a displacement map, based on distance data, for a first two-dimensional image using a computer-based system. The distance data represents a distance between an image object and a first position. A shifted version of the first two-dimensional image is produced based on the displacement map. Then, the first two-dimensional image and the shifted version of the first two-dimensional image are combined to produce a first three-dimensional image.

In another embodiment of the present invention, there is provided a system for synthesizing three-dimensional images that includes a displacement map generator, an image shifter, and an image synthesizer system. The displacement map generator generates a displacement map, based on distance data, for a first two-dimensional image. The distance data represents a distance between an image object and a first position. The image shifter produces a shifted version of the first two-dimensional image based on the displacement map. The image synthesizer system then combines the first two-dimensional image and the shifted version of the first two-dimensional image to produce a first three-dimensional image.

Further embodiments of the present invention enable displaying three-dimensional images, forming panoramic three-dimensional images by combining two three-dimensional images, and producing additional panoramic three-dimensional images based on additional positions.

Embodiments of the present invention may be implemented using hardware, software, or a combination thereof and may be implemented in one or more computer systems or other processing systems.

Further embodiments, features, and advantages of the present invention, as well as the structure and operation of the various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the information contained herein.

### BRIEF DESCRIPTION OF THE DRAWINGS/FIGURES

Embodiments of the present invention are described, by way of example only, with reference to the accompanying drawings. In the drawings, like reference numbers may indicate identical or functionally similar elements. The drawing in which an element first appears is typically indicated by the leftmost digit or digits in the corresponding reference number. Further, the accompanying drawings, which are incorporated herein and form part of the specification, illustrate the embodiments of present invention and, together with the description, further serve to explain the principles of the invention and to enable a person skilled in the relevant art(s) to make and use the invention.

FIG. 1 is a diagram of an exemplary distributed system suitable for practicing an embodiment.

FIG. 2 is a diagram illustrating an example of how a mapping service can be integrated with an image viewer for viewing three-dimensional images, according to an embodiment of the present invention.

FIG. 3 is a diagram of an exemplary image viewer, according to an embodiment of the present invention.

FIG. 4 is a process flowchart of an exemplary method for synthesizing three-dimensional images, according to an embodiment of the present invention.

FIG. 5 is a diagram illustrating an example of how to produce and combine a first and a second component of a three-dimensional image, according to an embodiment of the present invention.

FIG. 6A depicts an example two-dimensional image that can be used to synthesize a three-dimensional image, according to an embodiment of the present invention.

FIG. 6B depicts an exemplary three-dimensional image synthesized from the two-dimensional image in FIG. 6A, according to an embodiment of the present invention.

FIG. 7 is an illustration of an example computer system in which embodiments can be implemented.

### DETAILED DESCRIPTION

While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

The present invention relates to synthesizing three-dimensional images and more particularly, to synthesizing a three-dimensional image from a two-dimensional image. In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

### I. Three-Dimensional Imaging

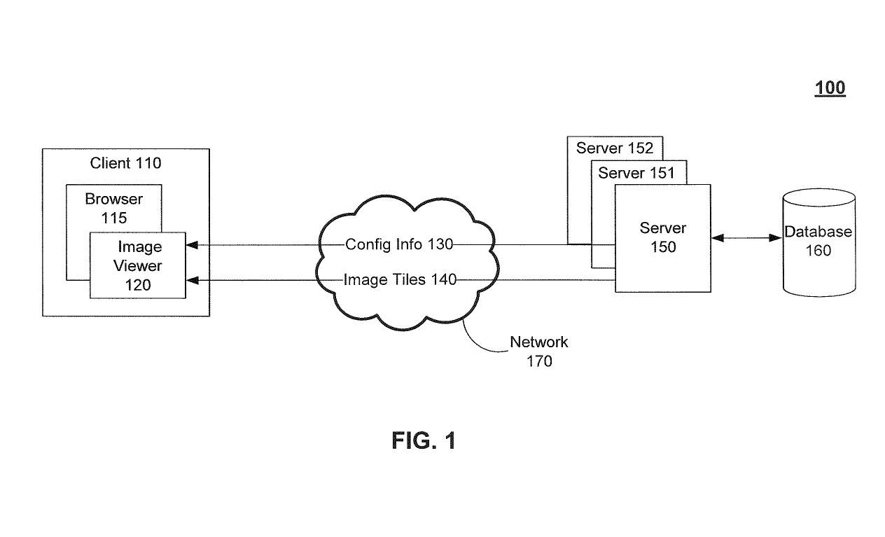

FIG. 1 is a diagram of distributed system 100 suitable for practice of an embodiment of the invention. In the example shown in FIG. 1, system 100 includes a client 110, a browser 115, an image viewer 120, configuration information 130, image tiles 140, servers 150, 151, and 152, a database 160 and a network 170.

Client 110 communicates with one or more servers 150, for example, across network 170. Although only servers 150-152 are shown, more servers may be used as necessary. Network 170 can be any network or combination of networks that can carry data communication. Such network can include, but is not limited to, a local area network, medium area network, and/or wide area network such as the Internet. Client 110 can be a general-purpose computer with a processor, local memory, a display, and one or more input devices such as a keyboard or a mouse. Alternatively, client 110 can be a specialized computing device such as, for example, a mobile handset. Servers 150-152, similarly, can be implemented using any general-purpose computer capable of serving data to client 110.

Client 110 executes an image viewer 120, the operation of which is further described herein. Image viewer 120 may be implemented on any type of computing device. Such computing device can include, but is not limited to, a personal computer, mobile device such as a mobile phone, workstation, embedded system, game console, television, set-top box, or any other computing device. Further, a computing device can include, but is not limited to, a device having a processor and memory for executing and storing instructions. Software may include one or more applications and an operating system. Hardware can include, but is not limited to, a processor, memory and graphical user interface display. The computing device may also have multiple processors and multiple shared or separate memory components. For example, the computing device may be a clustered computing environment or server farm.

As illustrated by FIG. 1, image viewer 120 requests configuration information 130 from server(s) 150. As discussed in further detail herein, the configuration information includes meta-information about an image to be loaded, including information on links within the image to other images. In an embodiment, the configuration information is presented in a form such as the Extensible Markup Language (XML). Image viewer 120 retrieves visual assets 140 for the image, for example, in the form of images or in the form of image tiles. In another embodiment, the visual assets include the configuration information in the relevant file format. Image viewer 120 presents a visual representation on the client display of the image and additional user interface elements, as generated from configuration information 130 and visual assets 140, as further described herein. As a user interacts with an input device to manipulate the visual representation of the image, image viewer 120 updates the visual representation and proceeds to download additional configuration information and visual assets as needed.

In an embodiment, images retrieved and presented by image viewer 120 are panoramas, for example, in the form of panoramic images or panoramic image tiles. In a further embodiment, images retrieved and presented by image viewer 120 are three-dimensional images, including panoramic three-dimensional images that can be presented on the client display. Client display can be any type of electronic display for viewing images or can be any type of rendering device adapted to view three-dimensional images. Further description of image viewer 120 and its operation as a panorama viewer can be found in commonly owned U.S. patent application Ser. No. 11/754,267, which is incorporated by reference herein in its entirety.

In an embodiment, image viewer 120 can be a standalone application, or it can be executed within a browser 115, such as Google Chrome or Microsoft Internet Explorer. Image viewer 120, for example, can be executed as a script within browser 115, as a plug-in within browser 115, or as a program which executes within a browser plug-in, such as the Adobe (Macromedia) Flash plug-in. In an embodiment, image viewer 120 is integrated with a mapping service, such as the one described in U.S. Pat. No. 7,158,878, “DIGITAL MAPPING SYSTEM,” which is incorporated by reference herein in its entirety.

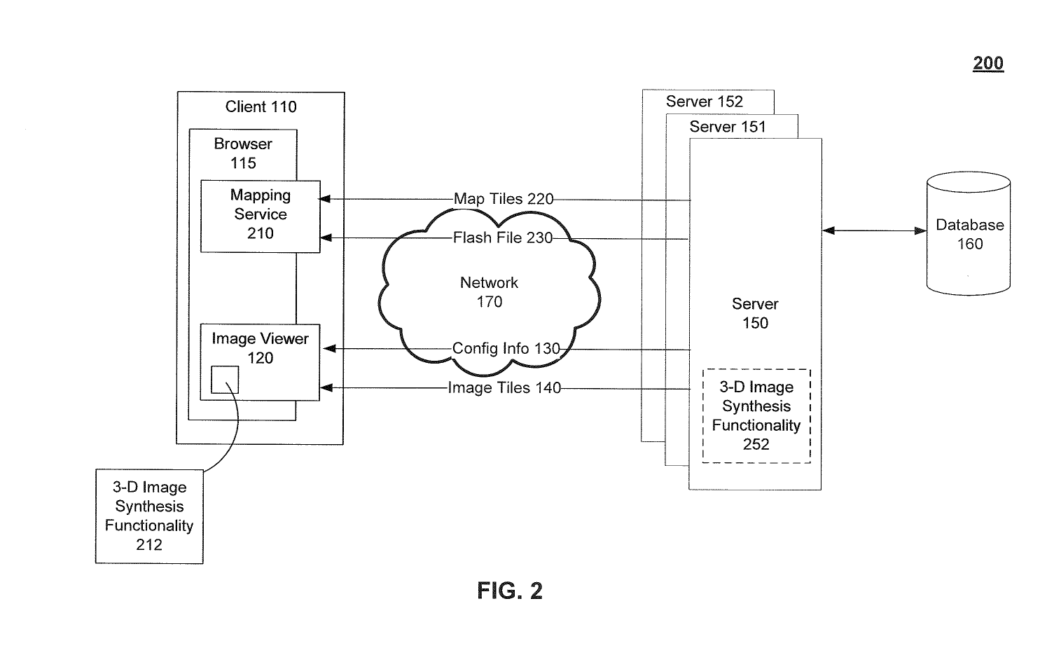

FIG. 2 illustrates system 200, including an example of how mapping service 210 can be integrated with image viewer 120 for viewing three-dimensional images according to an embodiment of the present invention. In the example shown in FIG. 2, system 200 includes mapping service 210, 3-D image synthesis functionality 212, map tiles 220, flash file 230, and 3-D Image synthesis functionality 252.

Mapping service 210 displays a visual representation of a map, e.g., as a viewport into a grid of map tiles. Mapping service 210 is implemented using a combination of markup and scripting elements, e.g., using HTML and Javascript. As the viewport is moved, mapping service 210 requests additional map tiles 220 from server(s) 150, assuming the requested map tiles have not already been cached in local cache memory. Notably, the server(s) which serve map tiles 220 can be the same or different server(s) from the server(s) which serve image tiles 140 or the other data involved herein.

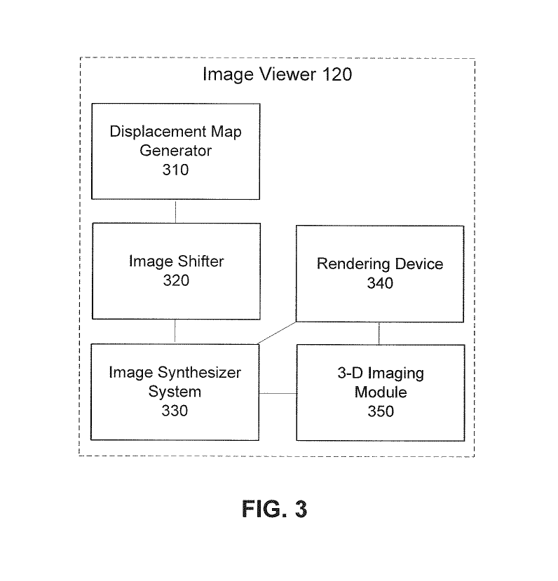

In an embodiment, image viewer 120 includes three-dimensional (“3-D”) image synthesis functionality 212. FIG. 3 is a diagram of image viewer 120 with 3-D image synthesis functionality according to an embodiment of the present invention. Image viewer 120 includes displacement map generator 310, image shifter 320, image synthesizer system 330, rendering device 340, and 3-D imaging module 350. In an embodiment displacement map generator 310 is coupled to image shifter 320, which is coupled to image synthesizer system 330. Image synthesizer system 330 is coupled to rendering device 340 and 3-D imaging module 350, according to an embodiment. In an embodiment, rendering device 340 is also coupled to 3-D imaging module 350.

In an embodiment, displacement map generator 310, image shifter 320, image synthesizer system 330, and 3-D imaging module 350 can be implemented in software, firmware, hardware, or a combination thereof. Embodiments of displacement map generator 310, image shifter 320, image synthesizer system 330, and 3-D imaging module 350, or portions thereof, can also be implemented as computer-readable code executed on one or more computing devices capable of carrying out the functionality described herein. Examples of computing devices include, but are not limited to, a central processing unit, an application-specific integrated circuit, or other type of computing device having at least one processor and memory.

### II. Distance Integration

In an embodiment, configuration information 130 includes distance data associated with a two-dimensional image. In an embodiment, the distance data is used to describe the proximity of an image object to a first position. The first position can be, for example, the position of a camera used to capture the image. In an embodiment, the surface of the image object may be represented as a collection of points. Each point, in turn, may be represented as a vector, whereby each point is stored with respect to its distance to the camera, and its angle with respect to the direction in which the camera is pointed. Such information may be collected using a laser range finder in combination with the camera taking the image.

Although some formats may be more advantageous than others, embodiments are not limited to any particular format of storing the distance data. In an embodiment, such distance data may be sent from server(s) 150 of system 100, illustrated in FIG. 1, to image viewer 120 as a depth map comprising a grid of discrete values, where each element of the grid corresponds with a pixel of a two-dimensional image. The value of the depth map at each pixel may represent the distance from a first position to an image object. For example, the value of the depth map at each pixel may represent the distance from a camera position, of the camera used to capture the image, and the image object represented in the image. In an embodiment, the distance data and other information associated with the image can be stored independently of the image itself. For example, configuration information 130 may contain the distance data for a two-dimensional image contained in image tiles 140.

The distance data may be collected in a variety of ways, including, but not limited to, using a laser range finder and image matching. In an embodiment, camera arrangements employing two or more cameras, spaced slightly apart yet looking at the same scene may be used. According to an embodiment, image matching is used to analyze slight differences between the images captured by each camera in order to determine the distance at each point in the images. In another embodiment, the distance information may be compiled by using a single video camera, mounted on a vehicle and traveling at a particular velocity, to capture images of scenes as the vehicle moves forward. By using image matching, the subsequent frames of the captured images may be compared to extract the different distances between the objects and the camera. For example, image objects located at a further distance from the camera position will stay in the frame longer than image objects located closer to the camera position.

Displacement map generator 310 uses the distance data, from configuration information 130 and associated with a two-dimensional image from image tiles 140, to generate a displacement map for the two-dimensional image. In an embodiment, the distance data may be stored in memory accessible by image viewer 120. As previously mentioned, distance data may be sent from server(s) 150 to image viewer 120 as a depth map comprising a grid of discrete values, where each element of the grid corresponds with a pixel of a two-dimensional image, according to an embodiment. For example, the elements of the depth map contain the amount of distance from a first position, such as a camera position, to the image object represented in the two-dimensional image. A displacement map is generated by using the distance values derived from the depth map. For each pixel of the two-dimensional image, the distance or depth value of the pixel can be used to generate a displacement value for the pixel. Further, the generated displacement value for a pixel is inversely proportional to the distance value of the pixel. The computation performed by displacement map generator 310 to generate a displacement value for each pixel of the two-dimensional image can be illustrated by the following expression:

$$d ( x , y ) = \frac{alpha}{D ( x , y )}$$

The term d(x,y) of the expression represents the displacement value stored as an element in the displacement map corresponding to a pixel, and the term D(x,y) represents the depth or distance value of the pixel, where x and y denote the coordinate location of the pixel in the image. The term alpha is a constant scale factor that can be used by displacement map generator 210 to control the displacement value, according to an embodiment. The scale factor also controls the degree of the three-dimensional effect in a three-dimensional image produced by image synthesizer system 330, discussed in further detail below.

Image shifter 320 is configured to use the displacement map generated by displacement map generator 310 to produce a shifted version of the two-dimensional image. In an embodiment, image shifter 320 is configured to laterally shift each of the plurality of pixels of the two-dimensional image by the displacement value, stored as an element of the displacement map corresponding to each of the plurality of pixels. For example, for a pixel located at coordinates (x,y) in the two-dimensional image, shifting the pixel laterally can be expressed as (x−d(x,y)), where d(x,y) is the displacement value as discussed above. In this example, the result of the operation (x−d(x,y)) may be a non-integer. In that case, an appropriate interpolation method, for example, but not limited to, natural neighbor (n-n), bi-linear, and bi-cubic, may be used. The appropriate interpolation method to use will depend on factors such as the available processing power. In addition, for the case of panoramic images, which tend to be spherical panoramas, wraparound along the x-axis is allowed by adding a width value, based on the dimensions of the spherical panorama, to the expression (x−d(x,y)). Therefore, if (x−d(x,y)) is less than zero, the expression (x−d(x,y)+width) is used in its place.

Image synthesizer system 330 combines the two-dimensional image and the shifted version of the two-dimensional image, produced by image shifter 320, to produce a three-dimensional image. In an embodiment, image synthesizer system 330 is configured to filter one or more first color channels of the two-dimensional image to produce a first component of the three-dimensional image. Color channels may include, for example, red, green, and blue (RGB) color channels associated with the RGB color model or standard for displaying color images. For example, image synthesizer system 330 can filter green and blue color channels of the two-dimensional image to produce the first component of the three-dimensional image. In an embodiment, image synthesizer system 330 is further configured to filter a second color channel, chromatically opposite to the first color channel, of the shifted version of the two-dimensional image to produce a second component of the three-dimensional image. Continuing with the previous example, image synthesizer system 330 can filter the red channel of the shifted version of the two-dimensional image to produce the second component. In an embodiment, image synthesizer system 330 is further configured to combine the one or more first color channels of the first component with the second color channel of the second component to produce the three-dimensional color image.

Notably, image synthesizer system 330 is not limited to configurations or embodiments that produce three-dimensional images by filtering color channels. Once the shifted version of a two-dimensional image is produced by image shifter 320, image synthesizer system 330 can be configured to operate with a variety of techniques for presenting three-dimensional images, such as, for example and without limitation, specialized three-dimensional displays, LCD shutter eyeglasses, and polarized displays with polarized eyeglasses. Other methods and techniques for viewing and displaying three-dimensional images would be known to a person of ordinary skill in the relevant art.

In an embodiment, rendering device 340 is configured to display the three-dimensional image produced by image synthesizer system 330. Rendering device 340 can be any visual rendering device that can include any type of display system that transforms display information, such as geometric, viewpoint, texture, lighting, and shading information, into a visual image. The image can be, for example, a digital image or raster graphics image, and can be displayed in either two or three dimensions.

In an embodiment, 3-D imaging module 350 is configured to combine two or more three-dimensional images to form a panoramic three-dimensional image, including panoramic three-dimensional images that comprise a 360-degree view of a scene. In an embodiment, 3-D imaging module 350 is configured to produce additional panoramic three-dimensional images based on additional positions, such as, for example, additional camera positions used to capture images representing different scenes. In an embodiment, image viewer 120 can be configured to view panoramic three-dimensional images via rendering device 340.

As described above, embodiments of displacement map generator 310, image shifter 320, image synthesizer system 330, and 3-D imaging module 350 can be operated solely at image viewer 120 at client 110. Alternatively, embodiments can be operated solely at the server via 3-D image synthesis functionality 252 at server(s) 150. In addition, embodiments can be operated entirely at one server, for example but not limited to, server 150. In addition, various components of 3-D image synthesis functionality 252, including any one or combination of embodiments of displacement map generator 310, image shifter 320, image synthesizer system 330, and 3-D imaging module 350, may be distributed among multiple servers, for example but not limited to, servers 150-152.

In an embodiment, mapping service 210 can request that browser 115 proceed to download a program 230 for image viewer 120 from server(s) 150 and to instantiate any plug-in necessary to run program 230. Program 230 may be a Flash file or some other form of executable content. Image viewer 120 executes and operates as described above. In addition, configuration information 130 and even image tiles 140, including panoramic image tiles, can be retrieved by mapping service 210 and passed to image viewer 120. Image viewer 120 and mapping service 210 communicate so as to coordinate the operation of the user interface elements, to allow the user to interact with either image viewer 120 or mapping service 210, and to have the change in location or orientation reflected in both.

As described above, embodiments of the present invention can be operated according to a client-server configuration. Alternatively, embodiments can be operated solely at the client, with configuration information 130, including distance data, image tiles 140, and map tiles 220 all available at the client. For example, configuration information 130, image tiles 140, and map tiles 220 may be stored in a storage medium accessible by client 110, such as a CD ROM or hard drive, for example. Accordingly, no communication with server(s) 150 would be needed.

### III. Method

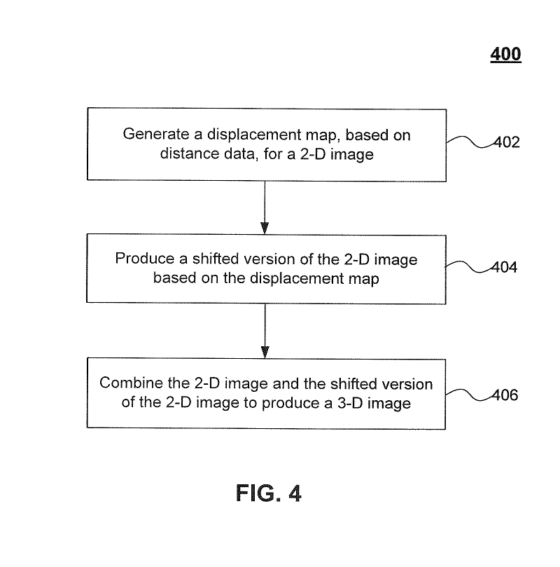

FIG. 4 is a process flowchart of a method 400 for synthesizing three-dimensional images, according to an embodiment of the present invention. Method 400 includes steps 402, 404, and 406. For ease of explanation, systems 100 and 200 of FIGS. 1 and 2 and image viewer 120 of FIG. 3, as described above, will be used to describe method 400, but is not intended to be limited thereto.

Referring back to FIG. 2, method 400 may be performed, for example, by image viewer 120 via 3-D image synthesis functionality 212. In addition, method 400 may be performed, for example by server(s) 150 via 3-D image synthesis functionality 252. However, depending on the preferences of users and implementation of system 200, it may not be desirable to use 3-D image synthesis functionality 252 on server(s) 150 to produce three-dimensional images. For instance, due to latency in transmitting three-dimensional images, produced by 3-D image synthesis functionality 252 at a server(s) 150, over network 170, the latency may lead to a poor experience for the user. In this case, in an embodiment, it may be desirable to use 3-D image synthesis functionality 212 on image viewer 120 (e.g., displacement map generator 310, image shifter 320, image synthesizer system 330, and 3-D imaging module 350 of FIG. 3).

Benefits of method 400, among others, are that it can be applied to panoramic images, works independently of the viewing direction of a scene represented in an image, can be implemented quickly and efficiently, and provides a good balance of efficiency and visual integrity. These benefits of method 400 lead to improved efficiency and user experience.

Method 400 begins in step 402, which includes generating a displacement map, based on distance data, for a first two-dimensional image. Step 402 may be performed, for example, by displacement map generator 310 of FIG. 3. As described above, the distance data represents a distance between an object in the first two-dimensional image and a first position, such as, for example, a camera position. In addition, as described above, the displacement map displacement map may be based on one or more of laser range data and image mapping, according to an embodiment.

In an embodiment, distance data represents, for each of a plurality of pixels of the first two-dimensional image, the distance from the first position to the image object represented in the first two-dimensional image at each pixel. Accordingly, generating the displacement map includes calculating a displacement value for each of the plurality of pixels. As described above, the displacement value is inversely proportional to the distance from the first position to the image object represented in the first two-dimensional image at each pixel, according to an embodiment. Also as described above, the displacement value for each of the plurality of pixels can be based on a constant scale factor, according to an embodiment. In an embodiment, the displacement map is based on one or more of laser range data and image mapping, as described above.

Method 400 proceeds to step 404, which includes producing a shifted version of the first two-dimensional image based on the displacement map. Step 404 may be performed, for example, by image shifter 320. In an embodiment, producing a shifted version of the first two-dimensional image includes laterally shifting each of the plurality of pixels of the two-dimensional image by the corresponding displacement value of each of the plurality of pixels.

Subsequently, in step 406, method 400 includes combining the first two-dimensional image and the shifted version of the first two-dimensional image to produce a first three-dimensional image. Step 406 may be tailored to comport with a variety of techniques for creating and displaying three-dimensional imagery, such as, for example and without limitation, specialized three-dimensional displays, LCD shutter eyeglasses, and polarized displays with polarized eyeglasses.

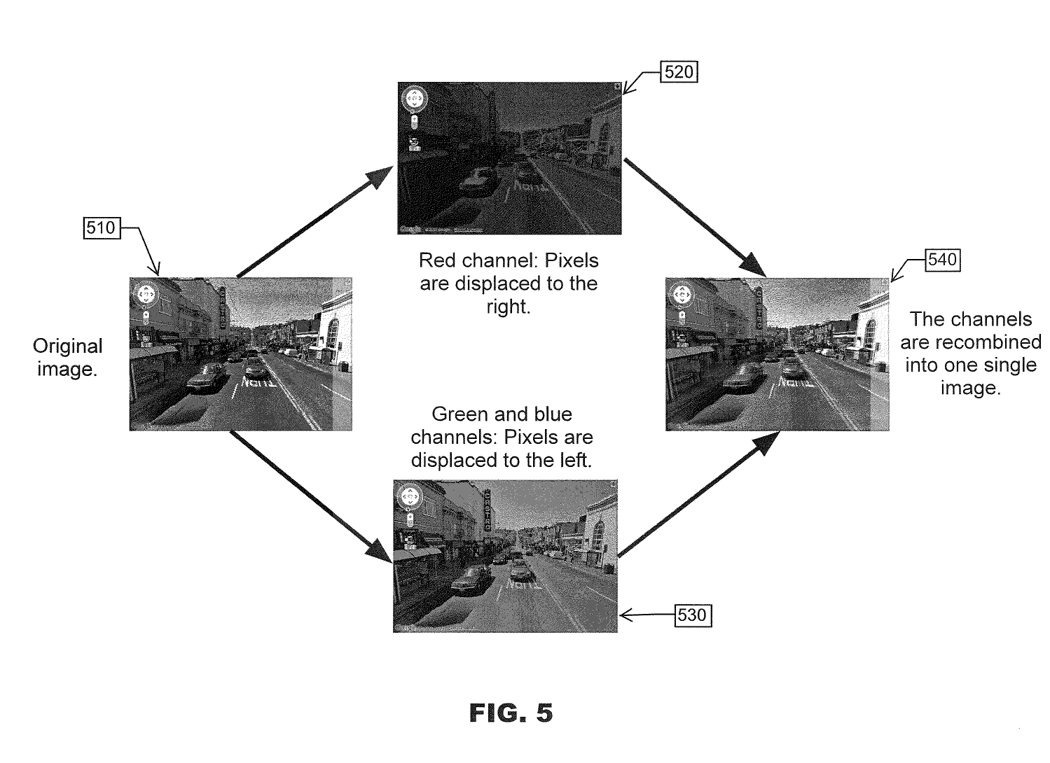

For example, in one embodiment, step 406 includes producing and combining a first and a second component of a three-dimensional image to produce a three-dimensional image. FIG. 5 is a diagram illustrating an example of how to produce and combine a first and a second component of a three-dimensional image according to an embodiment of step 406 of method 400 of FIG. 4. FIG. 5 includes images 510, 520, 530, and 540. Image 510 depicts an example two-dimensional image. Image 520 depicts a shifted version of the image 510, according to an embodiment. Image 540 depicts a three-dimensional version of image 510, according to an embodiment.

In one embodiment, step 406 includes filtering one or more first color channels of the first two-dimensional image to produce a first component of the first three-dimensional image. For example, the green and blue color channels of image 510 can be filtered in step 406 to produce image 530, according to an embodiment. Step 406 further includes filtering a second color channel, chromatically opposite to the first color channel, of the shifted version of the first two-dimensional image to produce a second component of the first three-dimensional image. For example, the red color channel of image 510 can be filtered in step 406 to produce image 520, according to an embodiment. Step 406 further includes combining the one or more first color channels of the first component of the first three-dimensional image with the second color channel of the second component of the first three-dimensional image to produce the first three-dimensional image. For example, images 520 and 530 are combined to produce the three-dimensional image 540. Step 406 may be performed, for example, by image synthesizer system 330.

In further embodiments, method 400 includes additional steps, which are not shown in FIG. 4 for ease of explanation. In one embodiment, method 400 includes displaying (e.g., using rendering device 340 of FIG. 3) the first three-dimensional image subsequent to step 406. In a further embodiment, method 400 includes displaying a viewport on a portion of the first three-dimensional image, the viewport including a three-dimensional overlay rendered with the first three-dimensional image. In that regard, method 400 further includes changing the three-dimensional overlay's orientation in three dimensional space as it is rendered with the first three-dimensional image so as to match a change in orientation of the viewport within the first three-dimensional image.

In another embodiment, method 400 includes producing a second three-dimensional image based on a second two-dimensional image (e.g., using three-dimensional imaging module 350 of FIG. 3) subsequent to step 406. In that regard, method 400 further includes combining the first and second three-dimensional images to form a first panoramic three-dimensional image. In an embodiment, the panoramic three-dimensional image may represent a 360 degree view of a scene. In an embodiment, method 400 includes producing a second panoramic three-dimensional image based on a second position, such as for example a second camera position.

### IV. Panoramic Three-Dimensional Street View Example

Services such as Google Maps are capable of displaying street level images of geographical locations. The images, known on Google Maps as “Street View,” typically comprise photographs of buildings and other features, and allow a user to view a geographic location from a street level perspective (e.g., a person walking on the street at the geographic location) as compared to a top-down map perspective. In one aspect, street level images are panoramic images, such as 360 degree panoramas centered at the geographic location associated with an image. The panoramic street-level view may be created by stitching together a plurality of photographs representing different perspectives from a geographical vantage point.

In an embodiment, mapping service 210 of FIG. 2 is configured to provide a visual indicator, such as a button, for enabling “Street View” that, when selected, preferably changes the appearance of the map in areas where panorama data is available. For example, streets with available panorama data may be highlighted. The mapping service also allows a user to activate image viewer 120 by further selecting a point on the map. When a point is selected by the user, a character or avatar icon is displayed at the point on the map. In an embodiment, the avatar icon includes an indicator of what direction the avatar icon is facing.

In an embodiment, as image viewer 120 is instantiated by mapping service 210, image viewer 120 is presented in the form of a viewport embedded in an informational balloon window associated with the avatar icon. The orientation of the visual representation of the panorama within the viewport matches the orientation of the avatar icon. As the user manipulates the visual representation of the panorama within the viewport, image viewer 120 informs the mapping service of any changes in orientation or location so that the mapping service can update the orientation and location of the avatar icon. Likewise, as the user manipulates the orientation or location of the avatar icon within mapping service 210, mapping service 210 informs image viewer 120 so that the image viewer 120 can update its visual representation.

In an embodiment, the viewport of image viewer 120 presents a panoramic image of the selected area. The user can click and drag around on the image to look around 360 degrees. For example, the viewport can present a variety of user interface elements that are added to the underlying panorama. These elements include navigation inputs such as, for example, zoom and panning controls (e.g., navigation buttons) on the left side of the viewport and annotations in the form of lines/bars, arrows, and text that are provided directly in the panorama itself. Further description of mapping service 210 and its operation in the context of Street View panoramas can be found in commonly owned U.S. patent application Ser. No. 11/754,267, which is incorporated by reference herein in its entirety.

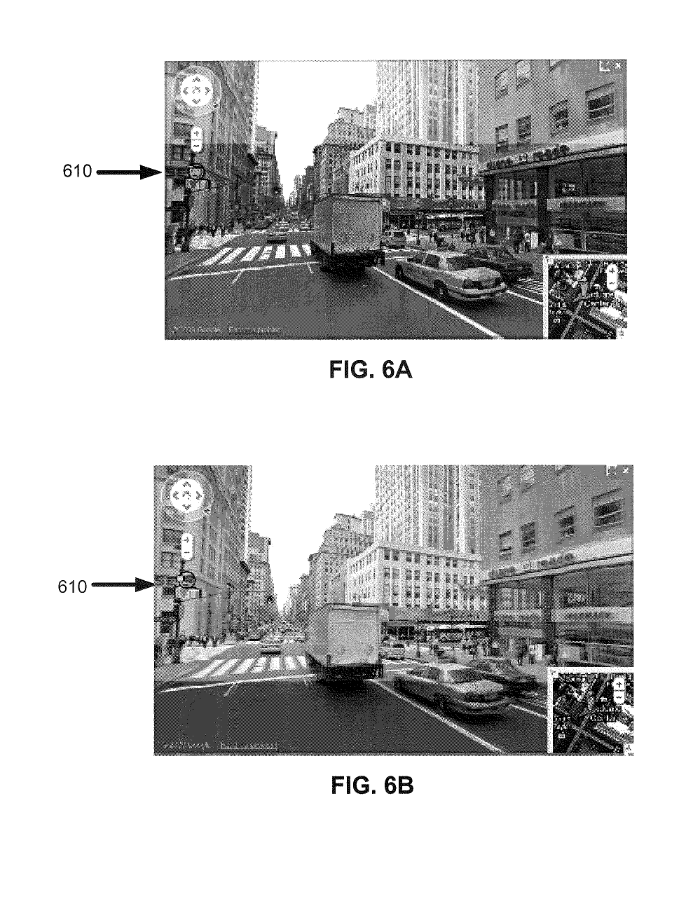

The panoramic images presented in the viewport of image viewer 120 have been two-dimensional panoramic images. In an embodiment, in addition to the user interface elements discussed above (e.g., navigation buttons), viewport of image viewer 120 further includes a 3-D user interface element (e.g., user interface element 610 in FIGS. 6A and 6B) associated with viewing a three-dimensional version of the panoramic image and displaying the three-dimensional panoramic image when the selected 3-D user interface element is selected.

FIGS. 6A and 6B depict example Street View images, according to an embodiment of the present invention. FIG. 6A depicts a typical two-dimensional Street View image of a scene. FIG. 6B depicts a three-dimensional Street View image of the same scene. User interface element 610 in FIG. 6A can be selected or enabled by a user viewing the Street View image in the viewport of image viewer 120 of FIG. 2. In an embodiment, when user interface element 610 is selected or enabled, 3-D image synthesis functionality 212 produces a three-dimensional image of the current two-dimensional image currently being viewed by the user. For example, after selecting or enabling user interface element 610, the three-dimensional image in FIG. 6B is displayed in place of the two-dimensional image in FIG. 6A.

### V. Example Computer System Implementation

Aspects of the present invention shown in FIGS. 1-6, or any part(s) or function(s) thereof, may be implemented using hardware, software modules, firmware, tangible computer readable media having instructions stored thereon, or a combination thereof and may be implemented in one or more computer systems or other processing systems.

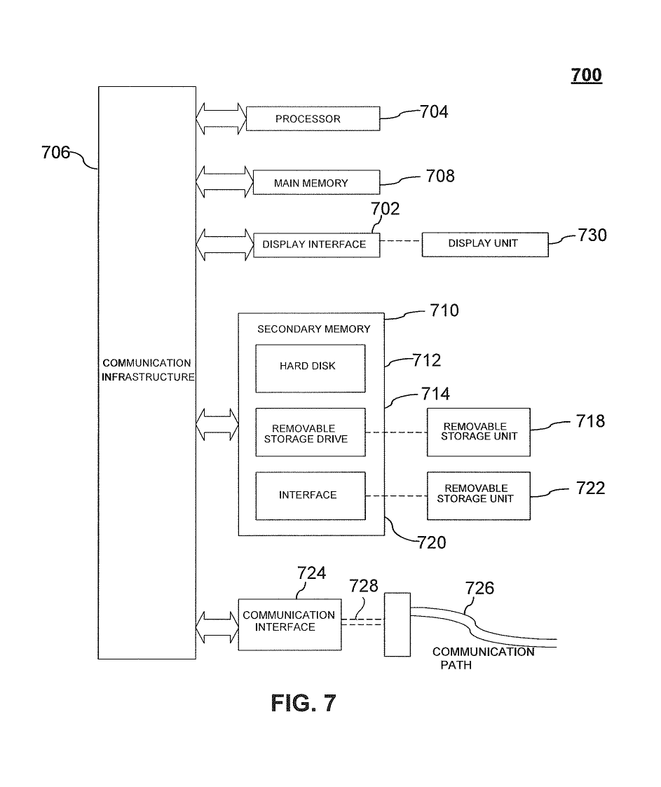

FIG. 7 illustrates an example computer system 700 in which embodiments of the present invention, or portions thereof, may by implemented as computer-readable code. For example, system 400, can be implemented in computer system 700 using hardware, software, firmware, tangible computer readable media having instructions stored thereon, or a combination thereof and may be implemented in one or more computer systems or other processing systems. Hardware, software, or any combination of such may embody any of the modules and components in FIGS. 1-6.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computer linked or clustered with distributed functions, as well as pervasive or miniature computers that may be embedded into virtually any device.

For instance, at least one processor device and a memory may be used to implement the above described embodiments. A processor device may be a single processor, a plurality of processors, or combinations thereof. Processor devices may have one or more processor “cores.”

Various embodiments of the invention are described in terms of this example computer system 700. After reading this description, it will become apparent to a person skilled in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. As will be appreciated by persons skilled in the relevant art, processor device 704 may also be a single processor in a multi-core/multiprocessor system, such system operating alone, or in a cluster of computing devices operating in a cluster or server farm. Processor device 704 is connected to a communication infrastructure 706, for example, a bus, message queue, network, or multi-core message-passing scheme.

Computer system 700 also includes a main memory 708, for example, random access memory (RAM), and may also include a secondary memory 710. Secondary memory 710 may include, for example, a hard disk drive 712, removable storage drive 714. Removable storage drive 714 may comprise a floppy disk drive, a magnetic tape drive, an optical disk drive, a flash memory, or the like. The removable storage drive 714 reads from and/or writes to a removable storage unit 718 in a well known manner. Removable storage unit 718 may comprise a floppy disk, magnetic tape, optical disk, etc. which is read by and written to by removable storage drive 714. As will be appreciated by persons skilled in the relevant art, removable storage unit 718 includes a computer usable storage medium having stored therein computer software and/or data.

In alternative implementations, secondary memory 710 may include other similar means for allowing computer programs or other instructions to be loaded into computer system 700. Such means may include, for example, a removable storage unit 722 and an interface 720. Examples of such means may include a program cartridge and cartridge interface (such as that found in video game devices), a removable memory chip (such as an EPROM, or PROM) and associated socket, and other removable storage units 722 and interfaces 720 which allow software and data to be transferred from the removable storage unit 722 to computer system 700.

Computer system 700 may also include a communications interface 724. Communications interface 724 allows software and data to be transferred between computer system 700 and external devices. Communications interface 724 may include a modem, a network interface (such as an Ethernet card), a communications port, a PCMCIA slot and card, or the like. Software and data transferred via communications interface 724 may be in the form of signals, which may be electronic, electromagnetic, optical, or other signals capable of being received by communications interface 724. These signals may be provided to communications interface 724 via a communications path 726. Communications path 726 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 718, removable storage unit 722, and a hard disk installed in hard disk drive 712. Computer program medium and computer usable medium may also refer to memories, such as main memory 708 and secondary memory 710, which may be memory semiconductors (e.g. DRAMs, etc.).

Computer programs (also called computer control logic) are stored in main memory 708 and/or secondary memory 710. Computer programs may also be received via communications interface 724. Such computer programs, when executed, enable computer system 700 to implement the present invention as discussed herein. In particular, the computer programs, when executed, enable processor device 704 to implement the processes of the present invention, such as the stages in the method illustrated by flowchart 400 of FIG. 4 discussed above. Accordingly, such computer programs represent controllers of the computer system 700. Where the invention is implemented using software, the software may be stored in a computer program product and loaded into computer system 700 using removable storage drive 714, interface 720, and hard disk drive 712, or communications interface 724.

Embodiments of the invention also may be directed to computer program products comprising software stored on any computer useable medium. Such software, when executed in one or more data processing device, causes a data processing device(s) to operate as described herein. Embodiments of the invention employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

### VI. Variations

As would be understood by a person skilled in the art based on the teachings herein, several variations of the above described features of synthesizing three-dimensional images can be envisioned. These variations are within the scope of embodiments of the present invention. For the purpose of illustration only and not limitation, a few variations are provided herein. For example, one skilled in the art can envision several variations for generating a displacement map as in step 402 of method 400 of FIG. 4 (e.g., using displacement map generator 310 of FIG. 3). For example, a variation may include using a displaced depthmap technique in which a displacement map relative to a shifted version of the two-dimensional image (e.g., as produced in step 404) is generated in addition to the displacement map generated in step 402. To implement this variation, for each pixel in the shifted image, a search for pixels which correspond to it in the original two-dimensional image is conducted. The displacement map is generated according to the results of the search, which may produce either no corresponding pixels or one or more corresponding pixels. In other variations, a view-dependent displacement map may be generated for each view of a user.

### VII. Conclusion

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method for synthesizing three-dimensional images, comprising:
generating, using a computer-based system, a displacement map, based on distance data, for a first two-dimensional image, wherein the distance data represents a distance between an image object and a first position;
producing a shifted version of the first two-dimensional image based on the displacement map; and
combining the first two-dimensional image and the shifted version of the first two-dimensional image to produce a first three-dimensional image.

2. The method of claim 1, wherein the distance data represents, for each of a plurality of pixels of the first two-dimensional image, the distance from the first position to the image object represented in the first two-dimensional image at each pixel.

3. The method of claim 2, wherein generating the displacement map comprises calculating a displacement value for each of the plurality of pixels, the displacement value being inversely proportional to the distance from the first position to the image object represented in the first two-dimensional image at each pixel.

4. The method of claim 3, wherein generating the displacement map further comprises determining the displacement value for each of the plurality of pixels based on a constant scale factor.

5. The method of claim 3, wherein producing the shifted version of the first two-dimensional image comprises:
laterally shifting each of the plurality of pixels by the displacement value of each of the plurality of pixels.

6. The method of claim 5, wherein combining the first two-dimensional image and the shifted version of the first two-dimensional image comprises:
filtering one or more first color channels of the first two-dimensional image to produce a first component of the first three-dimensional image;
filtering a second color channel, chromatically opposite to the first color channel, of the shifted version of the first two-dimensional image to produce a second component of the first three-dimensional image; and
combining the one or more first color channels of the first component of the first three-dimensional image with the second color channel of the second component of the first three-dimensional image to produce the first three-dimensional image.

7. The method of claim 1, further comprising:
displaying the first three-dimensional image.

8. The method of claim 7, wherein displaying the first three-dimensional image comprises:
displaying a viewport on a portion of the first three-dimensional image, the viewport including a three-dimensional overlay rendered with the first three-dimensional image; and
changing the three-dimensional overlay's orientation in three dimensional space as it is rendered with the first three-dimensional image so as to match a change in orientation of the viewport within the first three-dimensional image.

9. The method of claim 1, further comprising:
producing a second three-dimensional image based on a second two-dimensional image; and
combining the first and second three-dimensional images to form a first panoramic three-dimensional image.

10. The method of claim 9, wherein the first panoramic three-dimensional image comprises a 360 degree view.

11. The method of claim 10, further comprising:
producing a second panoramic three-dimensional image based on a second position.

12. The method of claim 1, wherein the displacement map is based on one or more of laser range data and image matching.

13. A system for synthesizing three-dimensional images, comprising:
a displacement map generator to generate a displacement map, based on distance data, for a first two-dimensional image, wherein the distance data represents a distance between an image object and a first position;
an image shifter to produce a shifted version of the first two-dimensional image based on the displacement map; and
an image synthesizer system to combine the first two-dimensional image and the shifted version of the first two-dimensional image to produce a first three-dimensional image.

14. The system of claim 13, wherein the distance data represents, for each of a plurality of pixels of the first two-dimensional image, the distance from the first position to the image object represented in the first two-dimensional image at each pixel.

15. The system of claim 14, wherein the displacement map generator is configured to generate a displacement value for each of the plurality of pixels, the displacement value being inversely proportional to the distance from the first position to the image object represented in the image at each pixel.

16. The system of claim 15, wherein the displacement map generator is configured to determine the displacement value for each of the plurality of pixels based on a constant scale factor.

17. The system of claim 16, wherein the image shifter is configured to laterally shift each of the plurality of pixels by the displacement value of each of the plurality of pixels.

18. The system of claim 17, wherein the image synthesizer system is configured to filter one or more first color channels of the first two-dimensional image to produce a first component of the first three-dimensional image, further configured to filter a second color channel, chromatically opposite to the first color channel, of the shifted version of the first two-dimensional image to produce a second component of the first three-dimensional image, and further configured to combine the one or more first color channels of the first component of the first three-dimensional image with the second color channel of the second component of the first three-dimensional image to produce the first three-dimensional image.

19. The system of claim 13, further comprising:
a rendering device configured to display the first three-dimensional image.

20. The system of claim 19, wherein the rendering device is configured to display a viewport on a portion of the first three-dimensional image, the viewport including a three-dimensional overlay rendered with the first three-dimensional image and further configured to change the three-dimensional overlay's orientation in three dimensional space as it is rendered with the first three-dimensional image so as to match a change in orientation of the viewport within the first three-dimensional image.

21. The system of claim 13, further comprising:
a three-dimensional imaging module to combine the first three-dimensional image with a second three-dimensional image to form a first panoramic three-dimensional image.

22. The system of claim 21, wherein the first panoramic three-dimensional image comprises a 360 degree view.

23. The system of claim 21, wherein the three-dimensional imaging module is configured to produce a second panoramic three-dimensional image based on a second position.

24. The system of claim 13, wherein the displacement map is based on one or more of laser range data and image matching.
